(19) United States
(12) Patent Application Publication
(10) Pub. No.: US 2023/0234428 A1
(43) Pub. Date: Jul. 27, 2023

(54) SUPPORT APPARATUS FOR A GOLF CART WINDSHIELD, GOLF CART UTILIZING THE SAME AND RELATED METHODS

(71) Applicant: MCS Industries, Inc., Easton, PA (US)

(72) Inventors: Joshua Ryan MacNeel, Rogers, AZ (US); Robert Terry Coyle, JR., Palmer, PA (US); Richard Joseph Ehrhardt, Nazareth, PA (US)

(21) Appl. No.: 18/096,828

(22) Filed: Jan. 13, 2023

Related U.S. Application Data
(60) Provisional application No. 63/303,587, filed on Jan. 27, 2022.

(51) Int. Cl. B60J 1/06

(52) U.S. Cl. CPC B60J 1/06

(57) ABSTRACT

A support apparatus for maintaining a golf cart windshield in a partially open state, a golf cart which includes the support apparatus, and related methods. The support apparatus may include an arm assembly that is length adjustable. First and second suction cup assemblies may be pivotably coupled to opposite ends of the arm assembly. In use, the first suction cup assembly may be adhered to a lower portion of the windshield while the second suction cup assembly is adhered to an upper portion of the windshield to maintain the windshield in one of a plurality of different partially open positions. The particular open state/position of the windshield may be dictated by the length of the arm assembly, the angle of the first and second suction cup assemblies relative to the arm assembly, and the position of the first suction cup assembly along the lower portion of the windshield.

### CROSS-REFERENCE TO RELATED APPLICATIONS

The present application claims priority to U.S. Provisional Patent Application Ser. No. 63/303,587, filed Jan. 27, 2022, the entirety of which is incorporated herein by reference.

### BACKGROUND OF THE INVENTION

Golf carts often have a fold down windshield whereby the windshield has a fixed lower portion and a pivotable upper portion that is coupled to the fixed lower portion by a hinge. The pivotable upper portion may be alterable between a closed position and an open position. In the closed position, the upper and lower portions lie in a common plane and close a front opening of the golf cart. The upper portion may be attached to a frame of the golf cart in the closed position to maintain this position. To achieve the open position, the pivotable upper portion may be detached from the frame of the golf cart and then pivoted downwardly about the hinge so that the upper portion of the windshield overlies the lower portion of the windshield. In this position, a large opening is formed to allow air to flow to the driver or passenger. However, windshields of the type described above are only capable of being fully opened or fully closed. Thus, a need exists for an apparatus, method, and/or system that can maintain the windshield in a partially open state.

### SUMMARY OF THE INVENTION

The present invention is directed to a support apparatus for maintaining a golf cart windshield in a partially open state, a golf cart which includes the support apparatus, and related methods. The support apparatus may include an arm assembly that is length adjustable. First and second suction cup assemblies may be pivotably coupled to opposite ends of the arm assembly. In use, the first suction cup assembly may be adhered to a lower portion of the windshield while the second suction cup assembly is adhered to an upper portion of the windshield to maintain the windshield in one of a plurality of different partially open positions. The particular open state/position of the windshield may be dictated by the length of the arm assembly, the angle of the first and second suction cup assemblies relative to the arm assembly, and the position of the first suction cup assembly along the lower portion of the windshield.

In one aspect, the invention may be a support apparatus for maintaining a golf cart windshield having an upper portion and a lower portion that are hingedly coupled together in a partially open state, the support apparatus comprising: an arm assembly comprising a first end, a second end, and a length measured between the first and second ends, wherein the length of the arm assembly is adjustable; a first suction cup assembly pivotably coupled to the first end of the arm assembly, the first suction cup assembly extending from the first end of the arm assembly at a first angle that is adjustable by pivoting the first suction cup assembly relative to the arm assembly; a second suction cup assembly pivotably coupled to the second end of the arm assembly, the second suction cup assembly extending from the second end of the arm assembly at a second angle that is adjustable by pivoting the second suction cup assembly relative to the arm assembly; and wherein the first suction cup assembly is configured for attachment to the lower portion of the golf cart windshield and the second suction cup assembly is configured for attachment to the upper portion of the golf cart windshield to support the upper portion of the golf cart windshield at a third angle relative to the lower portion of the golf cart windshield, wherein the third angle is adjustable by altering one or more of: (1) the length of the arm assembly; (2) the first angle; (3) the second angle; and (4) a position of the first suction cup assembly along the lower portion of the golf cart windshield.

In another aspect, the invention may be a golf cart comprising: a windshield comprising a lower portion, an upper portion, and a hinge connecting the upper portion to the lower portion, wherein the upper portion is pivotable relative to the lower portion about the hinge to alter the windshield between a closed state and an open state; a support apparatus comprising: an arm assembly comprising a first end, a second end, and a length measured between the first and second ends, wherein the length of the arm assembly is adjustable; a first suction cup assembly pivotably coupled to the first end of the arm assembly; and a second suction cup assembly pivotably coupled to the second end of the arm assembly; and wherein the first suction cup assembly is adhered to the lower portion of the windshield and the second suction cup assembly is adhered to the upper portion of the windshield to maintain the windshield in a partially open state.

In yet another aspect, the invention may be a method of controlling air flow through a windshield of a golf cart, the method comprising: attaching a first suction cup assembly that is pivotably coupled to a first end of an arm assembly of a support apparatus to a lower portion of the windshield of the golf cart; adjusting a length of the arm assembly; pivoting an upper portion of the windshield of the golf cart towards the lower portion of the windshield of the golf cart until the upper portion of the windshield of the golf cart is at a desired angle relative to the lower portion of the windshield of the golf cart; and attaching a second suction cup assembly that is pivotably coupled to a second end of the arm assembly of the support apparatus to the upper portion of the windshield of the golf cart to maintain the upper portion of the windshield of the golf cart at the desired angle.

Further areas of applicability of the present invention will become apparent from the detailed description provided hereinafter. It should be understood that the detailed description and specific examples, while indicating the preferred embodiment of the invention, are intended for purposes of illustration only and are not intended to limit the scope of the invention.

### BRIEF DESCRIPTION OF THE DRAWINGS

The present invention will become more fully understood from the detailed description and the accompanying drawings, wherein:

FIG. 1 is a perspective view of a golf cart with a windshield thereof in a closed state

FIG. 2 is a perspective view of the golf cart of FIG. 1 with the windshield in an open state;

FIG. 3 is a partial side view of a golf cart with the windshield being supported by a support apparatus to maintain the windshield in a partially open state;

FIG. 4 is a front view of a support apparatus for maintaining a golf cart windshield in a partially open state in accordance with an embodiment of the present invention;

FIG. 5 is a cross-sectional view taken along line V-V of FIG. 4;

FIG. 6 is an exploded perspective view of the support apparatus of FIG. 4;

FIGS. 7A-7C are front views of the support apparatus of FIG. 4 illustrating length adjustability;

FIGS. 8A and 8B are front views of the support apparatus of FIG. 4 illustrating first and second suction cup assemblies thereof being pivoted relative to an arm assembly thereof;

FIG. 9A is a partial side view of a golf cart with the support apparatus of FIG. 4 supporting the windshield in a first partially open state;

FIG. 9B is a close-up view of area IX of FIG. 9A;

FIG. 10A is a partial side view of a golf cart with the support apparatus of FIG. 4 supporting the windshield in a second partially open state;

FIG. 10B is a close-up view of area X of FIG. 10A;

FIG. 11A is a partial side view of a golf cart with the support apparatus of FIG. 4 supporting the windshield in a third partially open state; and

FIG. 11B is a close-up of area XI of FIG. 11A.

### DETAILED DESCRIPTION OF THE INVENTION

The following description of the preferred embodiment(s) is merely exemplary in nature and is in no way intended to limit the invention, its application, or uses.

The description of illustrative embodiments according to principles of the present invention is intended to be read in connection with the accompanying drawings, which are to be considered part of the entire written description. In the description of embodiments of the invention disclosed herein, any reference to direction or orientation is merely intended for convenience of description and is not intended in any way to limit the scope of the present invention. Relative terms such as “lower,” “upper,” “horizontal,” “vertical,” “above,” “below,” “up,” “down,” “top” and “bottom” as well as derivatives thereof (e.g., “horizontally,” “downwardly,” “upwardly,” etc.) should be construed to refer to the orientation as then described or as shown in the drawing under discussion. These relative terms are for convenience of description only and do not require that the apparatus be constructed or operated in a particular orientation unless explicitly indicated as such. Terms such as “attached,” “affixed,” “connected,” “coupled,” “interconnected,” and similar refer to a relationship wherein structures are secured or attached to one another either directly or indirectly through intervening structures, as well as both movable or rigid attachments or relationships, unless expressly described otherwise. Moreover, the features and benefits of the invention are illustrated by reference to the exemplified embodiments. Accordingly, the invention expressly should not be limited to such exemplary embodiments illustrating some possible non-limiting combination of features that may exist alone or in other combinations of features; the scope of the invention being defined by the claims appended hereto.

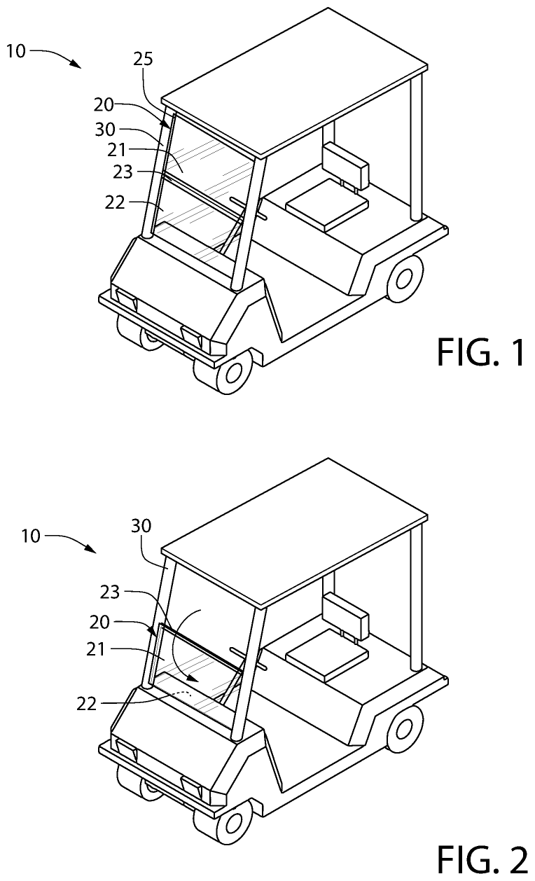

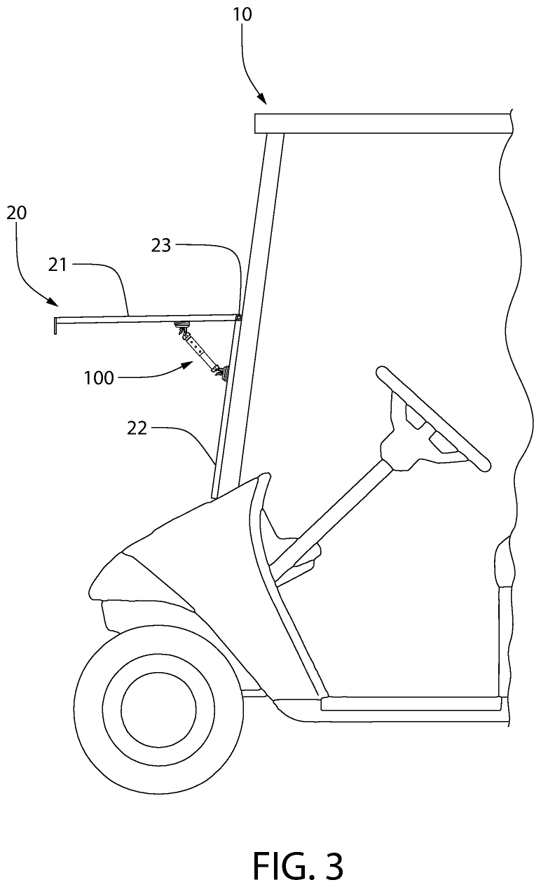

Referring to FIGS. 1 and 2, a golf cart 10 having a windshield 20 is illustrated to discuss the structure and function of the windshield 20. The windshield 20 comprises an upper portion 21 and a lower portion 22 that are coupled at a hinge 23. In FIG. 1, the windshield 20 is in a closed position, or a fully closed position. In the closed position, the upper and lower portions 21, 22 of the windshield 20 collectively close a front opening 25 of the golf cart 10. That is, the outer surfaces of the upper and lower portions 21, 22 of the windshield 20 lie in a common plane to cover the entirety of the front opening 25. The upper portion 21 of the windshield 20 may be fixed to a frame 30 of the golf cart 10 with clips, hook and loop fasteners, hardware fasteners, or the like.

The lower portion 22 of the windshield 20 may be fixed, meaning it cannot move relative to the frame 30. The upper portion 21 of the windshield 20 may be configured to move (i.e., pivot or rotate) relative to the lower portion 22 of the windshield 20. As shown in FIG. 2, the upper portion 22 of the windshield 20 may be configured to pivot about the hinge 23 of the windshield 20 relative to the lower portion 21 of the windshield 20. The upper portion 22 of the windshield 20 may be configured to pivot downwardly towards the lower portion 21 of the windshield 20 until outer surfaces of the upper and lower portions 22, 21 of the windshield 20 face one another (and may potentially be in contact with one another). Thus, in the open position (or fully open position) of the windshield 20 as shown in FIG. 2, the upper portion 22 of the windshield 20 may overlie or cover the lower portion 21 of the windshield 20. As a result, a portion of the front opening 25 of the golf cart 10 is open and not covered by the windshield 20. The windshield 20 may be repeatedly altered between the open and closed states as desired by the user to control air flow into the interior of the golf cart 10.

When the windshield 20 is in the open position of FIG. 2, air may flow through the open portion of the front opening 25 and into the cabin or interior of the golf cart 10. It has been determined that it may be possible to increase the air flow to the cabin or interior of the golf cart 10 by raising the upper portion 22 of the windshield 20 and maintaining the upper portion 22 of the windshield 20 at an angle relative to the lower portion 21 of the windshield 20. Such a positioning of the upper portion 22 of the windshield 20, referred to herein as a partially open state, may divert additional air into the interior of the golf cart 10 to achieve additional cooling of a driver and passenger located within the interior of the golf cart 10. The upper portion 22 of the windshield 20 may be in a partially open state when it is in any position between the fully closed state of FIG. 1 and the fully open state of FIG. 2. Generally, the upper portion 22 of the windshield 20 is oriented at an angle that is between 10° and 170°, more specifically between 10° and 150°, still more specifically between 20° and 150°, and still more specifically between 30° and 120° when in the partially open state. Of course, as noted above any position between the fully closed state and the fully open state may qualify as a partially open state.

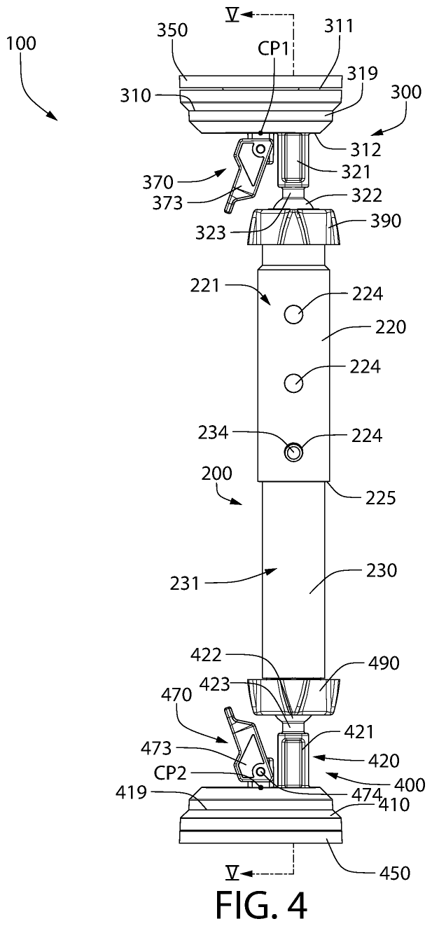

FIG. 3 illustrates the golf cart 10 with the windshield 20 comprising the upper portion 21 and the lower portion 22 that are connected at the hinge 23. In FIG. 3, the upper portion 21 of the windshield 20 is being supported by a support apparatus 100 to maintain the windshield 20 in a partially open state. The support apparatus 100 is attached or coupled or adhered to each of the upper and lower portions 21, 22 of the windshield 20 and serves to support the upper portion 21 of the windshield 20 so that it is maintained at an angle relative to the lower portion 21 of the windshield 20. While a single support apparatus 100 is depicted in FIG. 3, two or more of the support apparatuses 100 may be used to support the upper portion 21 of the windshield 20 at a desired angle in other embodiments. Moreover, the angle of the upper portion 21 relative to the lower portion 22 may be modified from the particular angle shown by making adjustments to the support apparatus 100, which will be described in detail below.

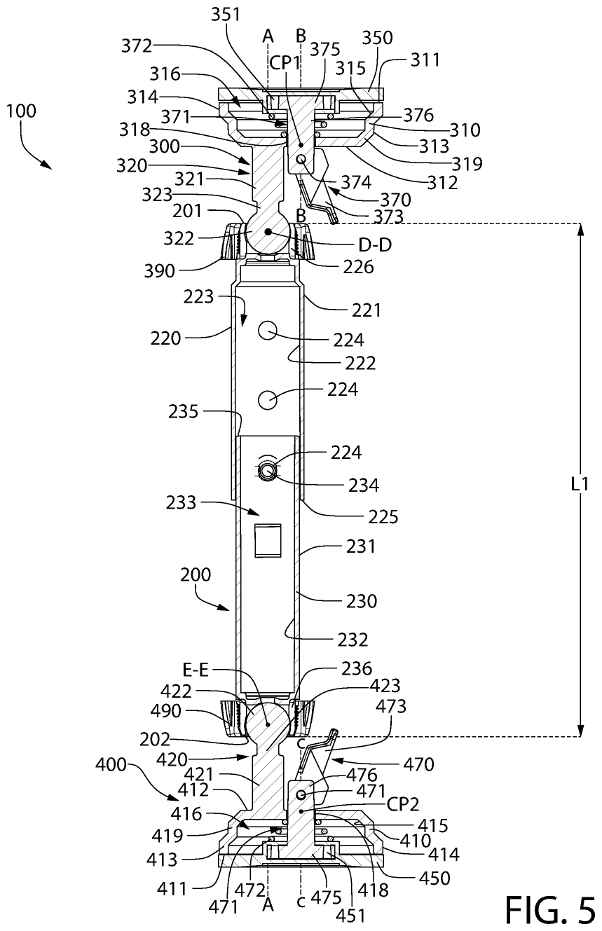

Referring to FIGS. 4-6, the support apparatus 100 will be described in detail. The support apparatus 100 may generally comprise an arm assembly 200, a first suction cup assembly 300, and a second suction cup assembly 400. The first and second suction cup assemblies 300, 400 may be pivotably coupled to opposite ends of the arm assembly 200 with a ball and socket joint. This may allow the first and second suction cup assemblies 300, 400 to pivot and/or swivel relative to the arm assembly 200. The first and second suction cup assemblies 300, 400 may have multiple degrees of movement relative to the arm assembly 200, including rotation along a first axis and pivoting along a second axis that is perpendicular to the first axis regardless of the rotational position of the first and second suction cup assemblies 300, 400. The first and second suction cup assemblies 300, 400 may be configured to pivot along an infinite number of second axes that are perpendicular to the first axis (with the first axis forming a longitudinal axis of the arm assembly 200).

The arm assembly 200 comprises a first end 201, a second end 202, and a longitudinal axis A-A extending in the direction between the first and second ends 201, 202. The arm assembly 200 has a length L1 measured between the first and second ends 201, 202 in the direction of the longitudinal axis A-A. The length L1 may be adjustable. While a specific technique for adjusting the length L1 will be described herein, alternative techniques and structures may be used in alternative embodiments to facilitate the length adjustment of the arm assembly 200.

The arm assembly 200 may comprise a first arm component 210 that comprises the first end 201 of the arm assembly 200 and a second arm component 220 that comprises the second end 202 of the arm assembly 200. The first arm component 210 may comprise the first end 201, an opposite second end 225, an outer surface 221, an inner surface 222, and a hollow interior 223 defined by the inner surface 222. The first arm component 210 may further comprise a plurality of locking apertures 224 that are formed through the thickness of the first arm component 210 from the outer surface 221 to the inner surface 222. Thus, each of the locking apertures 224 may form a transverse passageway from the exterior environment into the hollow interior 223 of the first arm component 210. In the exemplified embodiment, there are three of the locking apertures 224. In other embodiments, there may be two or more than three of the locking apertures 224. The locking apertures 224 may be positioned along the first arm component 210 in an axially spaced apart manner. The locking apertures 224 may be axially aligned as shown, although this is not required in all embodiments.

The first arm component 220 may comprise a first end portion 226 that comprises the first end 201 of the arm assembly 200. The first end portion 226 may comprise external threads 229 that are configured to mate with threads of a collar discussed below. The first end portion 226 may comprise a plurality of circumferentially spaced apart slits 227 extending from the first end 201 in a longitudinal direction along at least a portion of the length of the first end portion 226. The slits 227 divide the first end portion 226 into a plurality of first tabs 228. The first tabs 228 form fingers at the distal end of the first arm component 220. Due to the slits 227, the first tabs 228 may be capable of flexing outwardly away from the longitudinal axis and/or inwardly towards the longitudinal axis A-A of the arm component 200 when radially compressed which may help to securely couple the first suction cup assembly 300 to the first arm component 220, as described further below.

The first arm component 220 may be tubular with a cylindrical or round cross-sectional shape as shown. In other embodiments, the first arm component 220 may have other cross-sectional shapes, such as square, triangular, or the like. The specific cross sectional shape of the first arm component 220 is not to be limiting of the invention in all embodiments, although it should match with the cross-sectional shape of the second arm component 230 as described below.

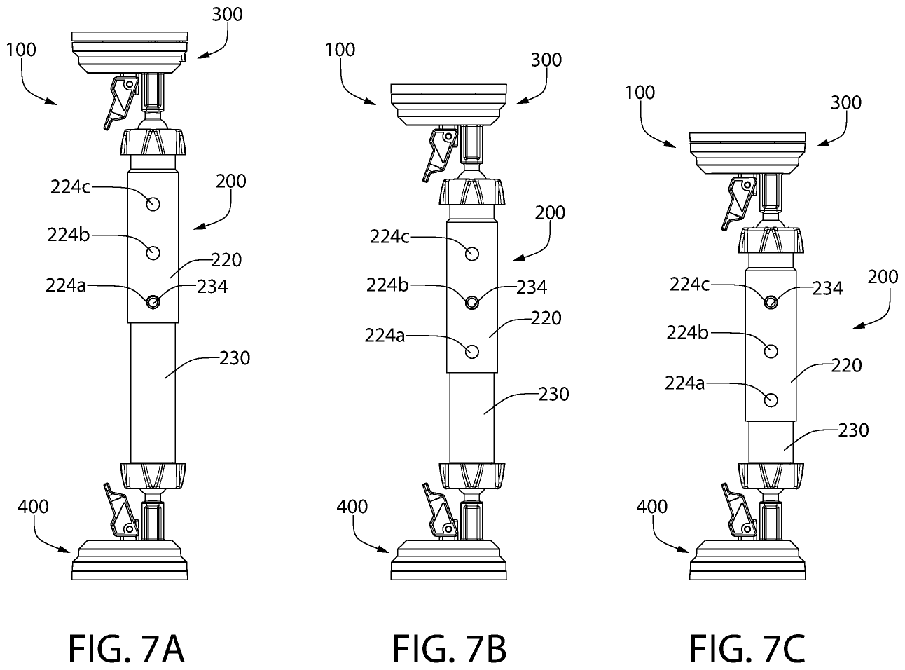

The second arm component 230 comprises the second end 202 of the arm assembly 200 and further comprises an opposite first end 235. The second arm component 230 further comprises an outer surface 231 and an inner surface 232 that may define a hollow interior 233. While the interior of the second arm component 230 is hollow in the exemplified embodiment, the invention is not to be so limited in all embodiments. The second arm component 230 may be solid rather than hollow or partially solid and partially hollow in other embodiments. The second arm component 230 may comprise a locking protuberance 234 protruding from the outer surface 232. The locking protuberance 234 may be biased into an outward protruding state, but capable of being pressed inwardly into the hollow interior 233. For example, the locking protuberance 234 may be operably coupled to a spring that biases the locking protuberance 234 into the position shown in FIG. 6, while permitting the locking protuberance 234 to be pressed inwardly to a position where it no longer protrudes beyond the outer surface 232 of the second arm component 230. That is, a user may be able to press the locking protuberance 234 into the hollow interior 233, but upon the user releasing pressure on the locking protuberance 234 the locking protuberance 234 may bias back to its protruding state as shown in FIG. 6. The locking protuberance 234 may be configured to mate with one of the locking apertures 224 of the first arm component 220 to lock the arm assembly 200 at a particular length.

The second arm component 230 may comprise a second end portion 236 that comprises the second end 202 of the arm assembly 200. The second end portion 236 may comprise external threads 239 that are configured to mate with threads of a collar discussed below. The second end portion 236 may comprise a plurality of circumferentially spaced apart slits 237 extending from the second end 202 in a longitudinal direction along at least a portion of the length of the second end portion 236. The slits 237 divide the second end portion 236 into a plurality of second tabs 238. The second tabs 238 may form fingers at the distal end of the second arm component 230. Due to the slits 237, the second tabs 238 may be capable of flexing outwardly away from the longitudinal axis and/or inwardly towards the longitudinal axis A-A of the arm component 200 which may help to securely couple the second suction cup assembly 400 to the second arm component 230, as described further below.

The second arm component 230 may be tubular with a cylindrical or round cross-sectional shape as shown. In other embodiments, the second arm component 230 may have other cross-sectional shapes, such as square, triangular, or the like. The specific cross sectional shape of the second arm component 230 is not to be limiting of the invention in all embodiments, although it should match with the cross-sectional shape of the first arm component 220 to facilitate the insertion of one into the other as described below.

The second arm component 230 may at least partially nest within the hollow interior 223 of the first arm component 220 to form the arm assembly 200. This is the reason that the cross-sectional shapes of the first and second arm components 220, 230 should be the same. The second arm component 230 may have a diameter which is less than the diameter of the first arm component 220 to enable the second arm component 230 to fit within the hollow interior 223 of the first arm component 220. The second arm component 230 may be configured to slide axially within the first arm component 220 so long as the locking protuberance 234 of the second arm component 230 is not engaged or mated with any of the locking apertures 224 of the first arm component 220.

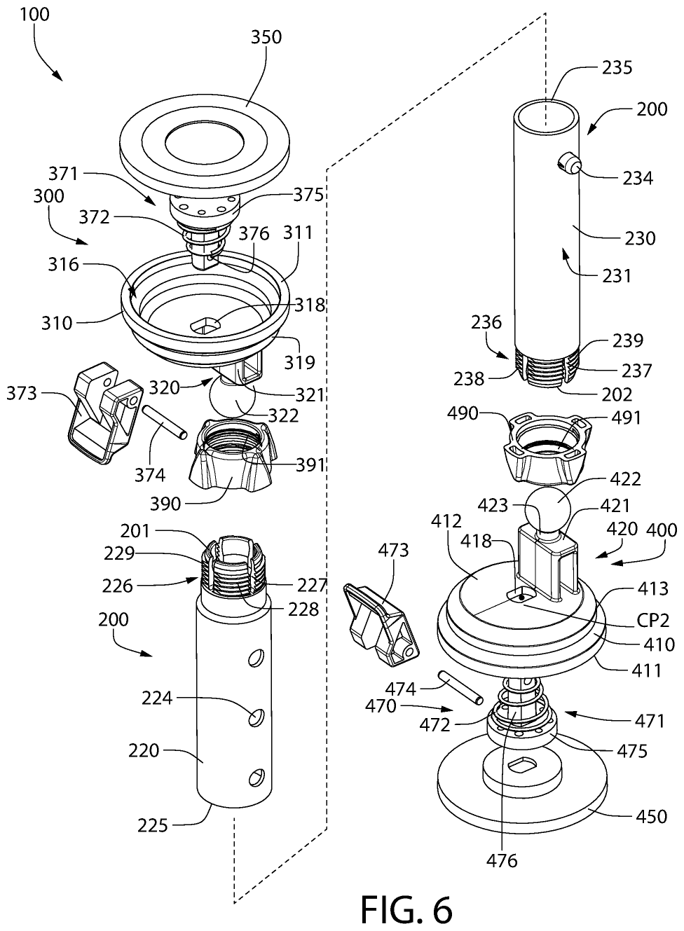

In FIGS. 4 and 5, the locking protuberance 234 is engaged with one of the locking apertures 224 that is located closest to the opposite second end 225 of the first arm component 220. The combination of the locking protuberance 234 and the locking apertures 224 may form a locking feature of the arm assembly 200 that locks the arm assembly 200 in a particular length. A user could push the locking protuberance 234 inwardly to disengage the locking protuberance 234 form the locking aperture 224 and then slide the second arm component 230 deeper into the hollow interior 223 of the first arm component 220 until the locking protuberance 234 mates with and/or engages another one of the locking apertures 224. That is, the first and second arm components 220, 230 may be slidable relative to one another in the axial direction to adjust the length L1 of the arm assembly 200. This movement of the second arm component 230 within the hollow interior 223 of the first arm component 220 may alter the length L1 of the arm assembly 200 as measured between the first and second ends 201, 202 thereof. Thus, the sliding of the second arm component 230 within the hollow interior 223 of the first arm component 220 may adjust the length L1 of the arm assembly 200. The engagement of the locking protuberance 234 with one of the locking apertures 224 may serve to lock the arm assembly 200 at a given length. In the exemplified embodiment the arm assembly 200 may be locked at three different lengths, one for each of the provided locking apertures 224. Additional adjustment is possible by adding more locking apertures 224.

Moreover, the locking protuberance 234 and locking apertures 224 is merely one way that the length of the arm assembly 200 may be made adjustable and lockable in different lengths. Other structures may be used to achieve this. In some embodiments, a locking collar may be threadedly coupled to the outer surface of the arm assembly 200 such that loosening the locking collar may allow the arm assembly 200 to be adjusted in length and tightening the locking collar may lock the arm assembly 200 at a particular length. In other embodiments, the first and second arm components 220, 230 may be twisted relative to one another to lengthen or shorten the arm assembly 200. The first and second arm components 220, 230 may be coupled together with a tight friction fit such that a sufficient force may lengthen or shorten the arm assembly 200 by sliding the first and second arm components 220, 230 relative to one another. Other possibilities exist for the lengthening and shortening of the arm assembly 200 and for locking the arm assembly 200 in various lengths as would be understood by persons skilled in the art.

The first suction cup assembly 300 comprises a first rigid shell 310, a first flexible sealing member 350, and a first actuation assembly 370. The first rigid shell 310 may be formed from a rigid plastic material, metal, wood, or the like. The first rigid shell 310 may comprise a first body portion 319 having a bottom end 311, a top end 312, and a sidewall 313 extending between the bottom and top ends 311, 312. The sidewall 313 may be wavy as shown or smooth in alternative embodiments. The top end 312 of the first body portion 319 may comprise a centerpoint CP1. The centerpoint CP1 may be intersected by a longitudinal axis B-B of the first body portion 319 which extends between the top and bottom ends 311, 312. The first body portion 319 of the first rigid shell 310 may also comprise an outer surface 314 and an inner surface 315. The inner surface 315 may define a cavity 316 and portions of the actuation assembly 370 may be located within the cavity 316.

The first body portion 319 of the first rigid shell 310 may comprise an aperture 318 in the top end 312. The aperture 318 may extend through the thickness of the top end 312 of the first body portion 319 to form a passageway into the cavity 316. The aperture 318 may be located along the centerpoint CP1 of the first body portion 319 and the aperture 318 may be intersected by the longitudinal axis B-B of the body portion 319. Portions of the first actuation assembly 370 may extend through the aperture 318 as detailed below.

The first rigid shell 310 further comprises a first connection element 320 which may be used for coupling the first suction cup assembly 300 to the arm assembly 200. The first connection element 320 may comprise a first post portion 321 extending from the top end 312 of the first body portion 319 and a first ball portion 322 that is attached to a distal end of the first post portion 321. The first post portion 321 may protrude from the top end 312 of the first body portion 319 at a location that is offset from the longitudinal axis B-B of the first body portion 319 and from the centerpoint CP1 of the top end 312 of the first body portion 319. The first post portion 321 may protrude or extend perpendicularly from the top end 312 of the first body portion 319. The first connection element 320 may comprise a first neck portion 323 that extends between the first post portion 321 and the first ball portion 322. The first body portion 319 and the first connection post 320 may be integrally formed as a singular, unitary, and monolithic part. That is, the first rigid shell 310 may comprise the first body portion 319 and the first connection element 320 which may be integral parts of the first rigid shell 310 which is a monolithic component.

The first flexible sealing member 350 may be formed from a flexible material, such as rubber, silicone, elastomer, or the like. The first flexible sealing member 350 may be positioned adjacent to the bottom end 311 of the first body portion 319 of the first rigid shell 310. The first flexible sealing member 350 forms the bottommost portion of the first suction cup assembly 300 and is exposed for contact with a surface to which the first suction cup assembly 300 is to be adhered or otherwise attached. The first flexible sealing member 350 may be a generally flat, disk-like structure which achieves the suction for attachment to a desired surface. The first flexible sealing member 350 is both held in place and actuated to create a suction by the first actuation assembly 370, as described below.

The first actuation assembly 370 may comprise an attachment member 371, a spring 372, a lever 373, and a pin 374. The attachment member 371 may be physically coupled to the first flexible sealing member 350. In the exemplified embodiment, the attachment member 371 comprises a post portion 375 and an annular flange portion 376 extending from a lower end of the post portion 375. In the exemplified embodiment, the flange portion 376 nests within an interior pocket 351 of the first flexible sealing member 350 to achieve the coupling of the first actuation assembly 370 to the first flexible sealing member 350. However, the invention is not to be so limited in all embodiments and the first actuation assembly 370 may be coupled to the first flexible sealing member 350 in other ways, such as using adhesives, clips, fasteners, etc.

The post portion 375 comprises a proximal portion that is located within the cavity 316 of the first body portion 319 of the first rigid shell 310 and a distal portion that extends through the aperture 318 and protrudes from the top end 312 of the first body portion 319 of the first rigid shell 310. The lever 373 is coupled to the distal portion of the post portion 375 via the pin 374. The pin 374 extends through openings in the lever 373 and in the distal portion of the post portion 375 of the attachment member 371 to couple the lever 373 to the attachment member 371.

The lever 373 (and hence also the first actuation assembly 370) is shown in a non-actuated state in FIGS. 4 and 5. The lever 373 (and hence also the first actuation assembly 370) may be altered into an actuated state by pivoting the free end of the lever 373 towards the top end 312 of the first body portion 319 of the first rigid shell 310. Such pivoting of the free end of the lever 373 will pull the attachment member 371 and a central portion of the first flexible sealing member 350 upwardly towards or further into the cavity 316. If the lever 373 is altered from the non-actuated state into the actuated state while the first flexible sealing member 350 is in contact with a surface, a vacuum may be formed between the first flexible sealing member 350 and the surface which may adhere the first flexible sealing member 350 (and the rest of the first suction cup assembly 300) to the surface. The spring 372 may assist with maintaining a strong suction between the first suction cup assembly 370 and the surface to which it is being attached (such as a portion of a golf cart windshield as described herein).

A collar 390 may be provided to facilitate the attachment of the first suction cup assembly 300 to the arm assembly 200, and more specifically to the first arm component 220 thereof. The collar 390 may comprise a threaded inner surface 391 which is configured to mate with the external threads 229 of the first end portion 226 of the first arm component 220. The outer surface of the collar 390 may comprise knurls, protrusions, or the like to facilitate easy gripping and rotation during coupling of the collar 390 to the arm assembly 200.

To attach the first suction cup assembly 300 to the arm assembly 200, the ball portion 322 of the first connection element 320 is inserted through the collar 390 and into the interior of the first end portion 226 of the first arm component 220 through the opening at the first end 201. When so positioned, the plurality of first tabs 228 surround the ball portion 322 of the first connection element 320. Furthermore, as the ball portion 322 is inserted into the interior of the first end portion 226 of the first arm component 220, the first tabs 228 may flex outwardly and therefore apply an inward force onto the ball portion 322. This may be dictated by the diameter of the opening to the interior of the first end portion 226 and the diameter of the ball portion 322.

Next, the collar 390 is threadedly coupled to the first end portion 226 of the first arm component 220 via threaded engagement between the threaded inner surface 391 of the collar 390 and the external threads 229 of the first end portion 226 of the first arm component 220. As the collar 390 is threaded onto the first end portion 226 of the first arm component 220, the collar 390 may cause the first tabs 228 to flex inwardly into contact and engagement with the outer surface of the ball portion 322 of the first connection element 320. Thus, once the collar 390 is threadedly coupled to the first end portion 226 of the first arm component 220, the ball portion 322 cannot be detached from the first arm component 220. In an embodiment, the collar 390 must be detached from the first end portion 226 of the first arm component 220 in order to detach the first suction cup assembly 300 from the arm assembly 200.

The ball portion 322 of the first connection element 320 and the interior of the first end portion 226 of the first arm component 220 forms a ball and socket joint. As such, the first suction cup assembly 300 is configured to pivot and rotate (i.e., swivel) relative to the arm assembly 200 when the suction cup assembly 300 is coupled to the arm assembly 200. The first suction cup assembly 300 may be capable of rotating 360° relative to the arm assembly 200 an unlimited number of times. The first suction cup assembly 300 may be further capable of pivoting relative to the arm assembly 200 in all directions regardless of the rotational position of the suction cup assembly 300 relative to the arm assembly 200. The first suction cup assembly 300 may be configured to rotate about the longitudinal axis A-A and to pivot about a pivoting axis D-D that is perpendicular to the longitudinal axis A-A. The movement of the first suction cup assembly 300 relative to the arm assembly 200 facilitates the ability of the support apparatus 100 to support the upper portion of the windshield of the golf cart at a variety of different partially open positions.

It should be noted that the pivoting axis D-D may be any axis that is perpendicular to the longitudinal axis A-A. That is, because the first suction cup assembly 300 is coupled to the arm assembly 200 via a ball and socket joint in the exemplified embodiment, the first suction cup assembly 300 is capable of pivoting in all directions along a 360° arc. Thus, while one particular pivoting axis D-D is called out in the drawings, the pivoting axis D-D is not a fixed and singular axis but is any axis which extends along a diameter of a ring or circle which surrounds the longitudinal axis A-A.

As noted above, the first connection element 320 of the first rigid shell 300 is offset from the centerpoint CP1 and from the longitudinal axis B-B of the first rigid shell 300. This can aid in improving and increasing the degrees and amount of movement and pivoting of the first suction cup assembly 300 that is possible relative to the arm assembly 200.

The second suction cup assembly 400 comprises a second rigid shell 410, a second flexible sealing member 450, and a second actuation assembly 470. The second rigid shell 410 may be formed from a rigid plastic material, metal, wood, or the like. The second rigid shell 410 may comprise a first body portion 419 having a bottom end 411, a top end 412, and a sidewall 413 extending between the bottom and top ends 411, 412. The sidewall 413 may be wavy as shown or smooth in alternative embodiments. The top end 412 of the second body portion 419 may comprise a centerpoint CP2. The centerpoint CP2 may be intersected by a longitudinal axis C-C of the second body portion 419 which extends between the top and bottom ends 411, 412. The second body portion 419 of the second rigid shell 410 may also comprise an outer surface 414 and an inner surface 415. The inner surface 415 may define a cavity 416 and portions of the actuation assembly 470 may be located within the cavity 416.

The second body portion 419 of the second rigid shell 410 may comprise an aperture 418 in the top end 412. The aperture 418 may extend through the thickness of the top end 412 of the second body portion 419 to form a passageway into the cavity 416. The aperture 418 may be located along the centerpoint CP2 of the second body portion 419 and the aperture 418 may be intersected by the longitudinal axis C-C of the body portion 419. Portions of the second actuation assembly 470 may extend through the aperture 418 as detailed below.

The second rigid shell 410 further comprises a second connection element 420 which may be used for coupling the second suction cup assembly 400 to the arm assembly 200. The second connection element 420 may comprise a second post portion 421 extending from the top end 412 of the second body portion 419 and a second ball portion 422 that is attached to a distal end of the second post portion 421. The second post portion 421 may protrude from the top end 412 of the second body portion 419 at a location that is offset from the longitudinal axis C-C of the second body portion 419 and from the centerpoint CP2 of the top end 412 of the second body portion 419. The second post portion 421 may protrude or extend perpendicularly from the top end 412 of the second body portion 419. The second connection element 420 may comprise a second neck portion 423 that extends between the second post portion 421 and the second ball portion 422. The second body portion 419 and the second connection post 420 may be integrally formed as a singular, unitary, and monolithic part. That is, the second rigid shell 410 may comprise the second body portion 419 and the second connection element 420 which may be integral parts of the second rigid shell 410 which is a monolithic component.

The second flexible sealing member 450 may be formed from a flexible material, such as rubber, silicone, or the like. The second flexible sealing member 450 may be positioned adjacent to the bottom end 411 of the second body portion 419 of the second rigid shell 410. The second flexible sealing member 450 forms the bottommost portion of the second suction cup assembly 400 and is exposed for contact with a surface to which the second suction cup assembly 400 is to be adhered or otherwise attached. The second flexible sealing member 450 may be a generally flat, disk-like structure which achieves the suction for attachment to a desired surface. The second flexible sealing member 450 is both held in place and actuated to create a suction by the second actuation assembly 470, as described below.

The second actuation assembly 470 may comprise an attachment member 471, a spring 472, a lever 473, and a pin 474. The attachment member 471 may be physically coupled to the second flexible sealing member 450. In the exemplified embodiment, the attachment member 471 comprises a post portion 475 and an annular flange portion 476 extending from a lower end of the post portion 475. In the exemplified embodiment, the flange portion 476 nests within an interior pocket 451 of the second flexible sealing member 450 to achieve the coupling of the second actuation assembly 470 to the second flexible sealing member 450. However, the invention is not to be so limited in all embodiments and the second actuation assembly 470 may be coupled to the second flexible sealing member 450 in other ways, such as using adhesives, clips, fasteners, etc.

The post portion 475 comprises a proximal portion that is located within the cavity 416 of the second body portion 419 of the second rigid shell 410 and a distal portion that extends through the aperture 418 and protrudes from the top end 412 of the second body portion 419 of the second rigid shell 410. The lever 473 is coupled to the distal portion of the post portion 475 via the pin 474. The pin 474 extends through openings in the lever 473 and in the distal portion of the post portion 475 of the attachment member 471 to couple the lever 473 to the attachment member 471.

The lever 473 (and hence also the second actuation assembly 470) is shown in a non-actuated state in FIGS. 4 and 5. The lever 473 (and hence also the second actuation assembly 470) may be altered into an actuated state by pivoting the free end of the lever 473 towards the top end 412 of the second body portion 419 of the second rigid shell 410. Such pivoting of the free end of the lever 473 will pull the attachment member 471 and a central portion of the second flexible sealing member 450 upwardly towards or further into the cavity 416. If the lever 473 is altered from the non-actuated state into the actuated state while the second flexible sealing member 450 is in contact with a surface, a vacuum may be formed between the second flexible sealing member 450 and the surface which may adhere the second flexible sealing member 450 (and the rest of the second suction cup assembly 400) to the surface. The spring 472 may assist with maintaining a strong suction between the second suction cup assembly 470 and the surface to which it is being attached (such as a portion of a golf cart windshield as described herein).

A collar 490 may be provided to facilitate the attachment of the second suction cup assembly 400 to the arm assembly 200, and more specifically to the second arm component 230 thereof. The collar 490 may comprise a threaded inner surface 491 which is configured to mate with the external threads 239 of the second end portion 236 of the second arm component 230. The outer surface of the collar 490 may comprise knurls, protrusions, or the like to facilitate easy gripping and rotation during coupling of the collar 490 to the arm assembly 200.

To attach the second suction cup assembly 400 to the arm assembly 200, the ball portion 422 of the second connection element 420 is inserted through the collar 490 and into the interior of the second end portion 236 of the second arm component 230 through the opening at the second end 202. When so positioned, the plurality of second tabs 238 surround the ball portion 422 of the second connection element 420. Furthermore, as the ball portion 422 is inserted into the interior of the second end portion 236 of the second arm component 230, the second tabs 238 may flex outwardly and therefore apply an inward force onto the ball portion 422. This may be dictated by the diameter of the opening to the interior of the second end portion 236 and the diameter of the ball portion 422.

Next, the collar 490 is threadedly coupled to the second end portion 236 of the second arm component 230 via threaded engagement between the threaded inner surface 491 of the collar 490 and the external threads 239 of the second end portion 236 of the second arm component 230. As the collar 490 is threaded onto the second end portion 236 of the second arm component 230, the collar 490 may cause the second tabs 238 to flex inwardly into contact and engagement with the outer surface of the ball portion 422 of the second connection element 420. Thus, once the collar 490 is threadedly coupled to the second end portion 236 of the second arm component 230, the ball portion 422 cannot be detached from the second arm component 230. In an embodiment, the collar 490 must be detached from the second end portion 236 of the second arm component 230 in order to detach the second suction cup assembly 400 from the arm assembly 200.

The ball portion 422 of the second connection element 420 and the interior of the second end portion 236 of the second arm component 230 may form a ball and socket joint. As such, the second suction cup assembly 400 may be configured to pivot and rotate (i.e., swivel) relative to the arm assembly 200 when the suction cup assembly 400 is coupled to the arm assembly 200. The second suction cup assembly 400 may be capable of rotating 460° relative to the arm assembly 200 an unlimited number of times. The second suction cup assembly 400 may be further capable of pivoting relative to the arm assembly 200 in all directions regardless of the rotational position of the suction cup assembly 400 relative to the arm assembly 200. The second suction cup assembly 400 may be configured to rotate about the longitudinal axis A-A and to pivot about a pivoting axis E-E that is perpendicular to the longitudinal axis A-A. The movement of the second suction cup assembly 400 relative to the arm assembly 200 facilitates the ability of the support apparatus 100 to support the upper portion of the windshield of the golf cart at a variety of different partially open positions.

It should be noted that the pivoting axis E-E may be any axis that is perpendicular to the longitudinal axis A-A. That is, because the second suction cup assembly 400 is coupled to the arm assembly 200 via a ball and socket joint in the exemplified embodiment, the second suction cup assembly 400 is capable of pivoting in all directions along a 360° arc. Thus, while one particular pivoting axis E-E is called out in the drawings, the pivoting axis E-E is not a fixed and singular axis but is any axis which extends along a diameter of a ring or circle which surrounds the longitudinal axis A-A.

As noted above, the second connection element 420 of the second rigid shell 400 is offset from the centerpoint CP2 and from the longitudinal axis C-C of the second rigid shell 400. This can aid in improving and increasing the degrees and amount of movement and pivoting of the second suction cup assembly 400 that is possible relative to the arm assembly 200.

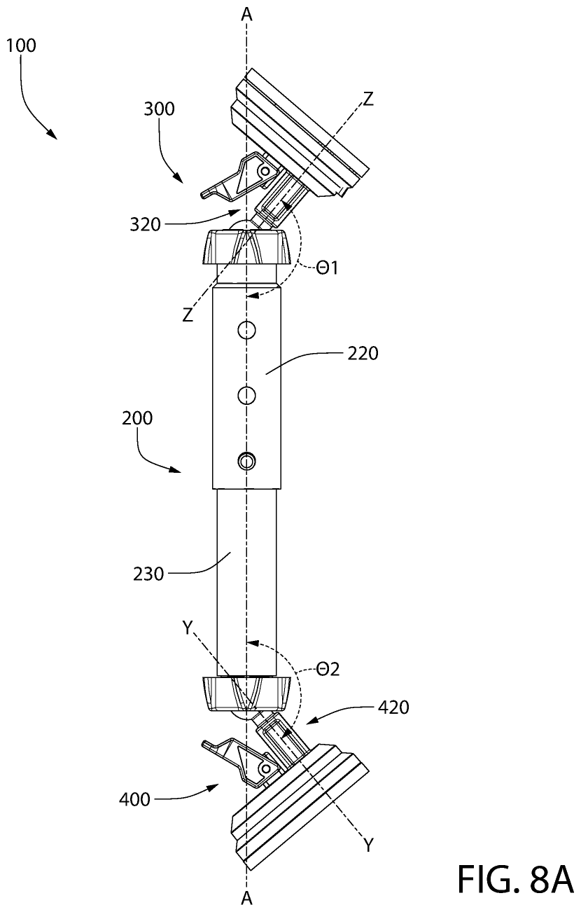

Referring to FIGS. 7A-7C, the length adjustment feature of the arm assembly 200 of the support apparatus 100 will be described. In the exemplified embodiment, the first arm component 220 of the arm assembly 200 comprises three of the locking apertures 224a-c. In FIG. 7A, the locking protuberance 234 of the first arm component 230 is mated with the first locking apertures 224a. When in this position, the length L1 of the arm assembly 200 is a first length. A user may press the locking protuberance 234 inwardly to disengage the locking protuberance 234 from the first locking aperture 224a. Once the locking protuberance 234 is disengaged from the first locking aperture 224a, the user may slide the second arm component 230 axially relative to the first arm component 220 in the direction of the first suction cup assembly 300 until the locking protuberance 234 becomes aligned with the second locking aperture 224a. Once the locking protuberance 234 becomes aligned with the second locking aperture 224a, the locking protuberance 234 may spring outwardly and through the second locking aperture 224a to lock the arm assembly 200 in the length shown in FIG. 7B. The same process may take place to lock the arm assembly 200 in the length shown in FIG. 7C whereby the locking protuberance 234 mates with the third locking aperture 224c. The same process may be followed to adjust the length of the arm assembly 200 from the length shown in FIG. 7C to the length shown in FIG. 7B or 7A.

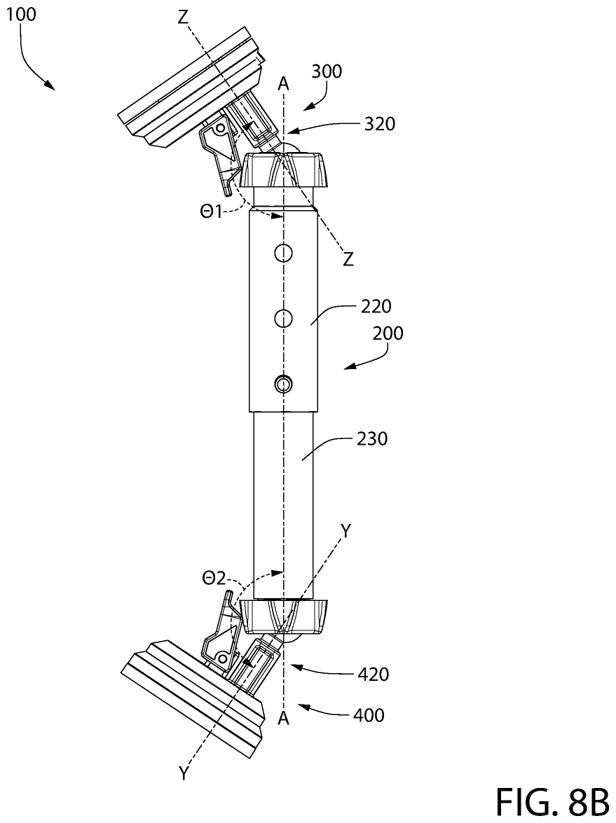

Referring to FIGS. 8A and 8B, the pivoting or swiveling movement of the first and second suction cup assemblies 300, 400 relative to the arm assembly 200 is illustrated. The first suction cup assembly 300 is pivotably coupled to the arm assembly 200 and extends from the arm assembly 200 at a first angle Θ1. The first angle Θ1 is formed between the longitudinal axis A-A of the arm assembly 200 and a first suction cup assembly axis Z-Z which forms a longitudinal axis of the first connection element 320 The first angle Θ1 may be adjusted by pivoting or swiveling the first suction cup assembly 300 relative to the arm assembly 200. While FIGS. 8A and 8B illustrate two positions of the first suction cup assembly 300 relative to the arm assembly 200, it should be appreciated that the ball and socket joint between the two components allows for many additional relative positions and angles. In some embodiments, the first angle Θ1 may be between 120° and 180°, or between 130° and 180°, or between 140° and 180°. The first suction cup assembly 300 may be capable of rotating about the longitudinal axis A-A regardless of the first angle Θ1.

The second suction cup assembly 400 is pivotably coupled to the arm assembly 200 and extends from the arm assembly 200 at a second angle Θ2. The second angle Θ2 is formed between the longitudinal axis A-A of the arm assembly 200 and a second suction cup assembly axis Y-Y which forms a longitudinal axis of the second connection element 420 The second angle Θ2 may be adjusted by pivoting or swiveling the second suction cup assembly 400 relative to the arm assembly 200. While FIGS. 8A and 8B illustrate two positions of the second suction cup assembly 400 relative to the arm assembly 200, it should be appreciated that the ball and socket joint between the two components allows for many additional relative positions and angles. In some embodiments, the second angle Θ2 may be between 120° and 180°, or between 130° and 180°, or between 140° and 180°. The second suction cup assembly 400 may be capable of rotating about the longitudinal axis A-A regardless of the first angle Θ2.

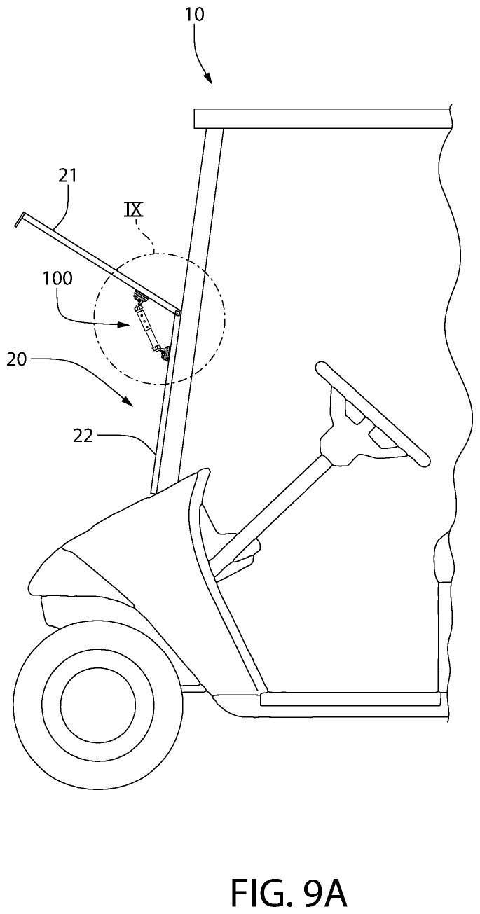

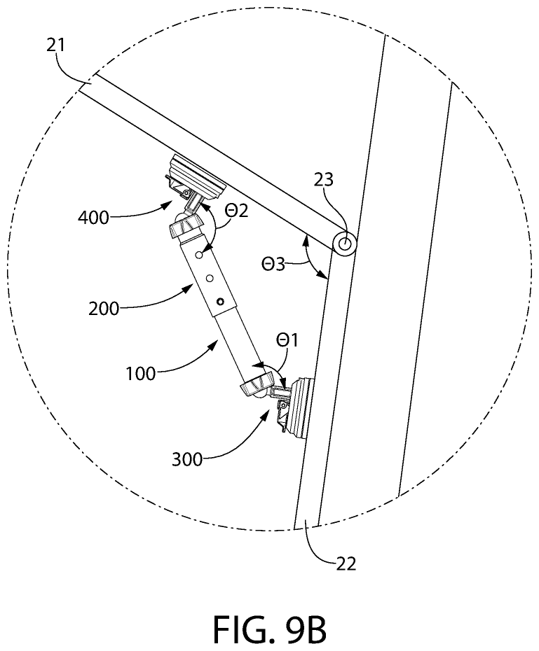

FIGS. 9A-11B illustrate the support arm 100 in use to support the upper portion 21 of the windshield 20 of the golf cart 10 at various different angles relative to the lower portion 22 of the windshield 20 of the golf cart 10.

Referring first to FIGS. 9A and 9B, the support arm 100 is supporting the upper portion 21 of the windshield 20 at a third angle Θ3 relative to the lower portion 22 of the windshield 20. To use the support arm 100 for this purpose, generally one of the first and second suction cup assemblies 300, 400 is first adhered to the outer surface of the lower portion 22 of the windshield 20 while the upper portion 21 of the windshield 20 is either in the fully closed state or held by the user. The length L1 of the arm assembly 200 is then adjusted as desired. Of course, the length L1 of the arm assembly 200 may be adjusted to the desired or selected length before adhering the one of the first and second suction cup assemblies 300, 400 to the lower portion 22 of the windshield 20. Alternatively, the length L1 of the arm assembly 200 may be adjusted at a later step in the process.

Next, the upper portion 21 of the windshield 20 is pivoted towards the lower portion 22 of the windshield 20 until the outer surface of the upper portion 21 of the windshield 20 contacts the other one of the first and second suction cup assemblies 300, 400. Further adjustments to the length L1, the first angle Θ1, and the second angle Θ2 may be made at this point to dictate the third angle Θ3. Finally, the other one of the first and second suction cup assemblies 300, 400 is adhered to the upper portion 21 of the windshield 20 so that the support apparatus 100 supports and maintains the upper portion 21 of the windshield 20 at the third angle Θ3 relative to the lower portion 22 of the windshield 20. As noted above, multiple of the support apparatuses 100 may be used in some embodiments, such as one being positioned adjacent to each side edge of the windshield 20. The support apparatus 100 may be a retrofit item that is used as desired by an end user to maintain the upper portion 21 of the windshield 20 in a desired orientation or angle relative to the lower portion 22 of the windshield 20.

The third angle may be adjusted by performing at least one of: (1) adjusting the length L1 of the arm assembly; (2) adjusting the first angle Θ1; (3) adjusting the second angle Θ2; and/or (4) adjusting a position of the one of the first and second suction cup assemblies 300, 400 along the lower portion 22 of the windshield 20. In some embodiments, at least two of the above features are adjusted to adjust the third angle Θ3. The adjustment of the position of the one of the first and second suction cup assemblies 300, 400 may comprise moving the one of the first and second suction cup assemblies 300, 400 that is adhered to the lower portion 22 of the windshield 20 either towards or away from the hinge 23 of the windshield. The first and second angle Θ1, Θ2 adjustments may occur automatically as the first and second suction cup assemblies 300, 400 are oriented so that the first and second flexible sealing members 350, 450 thereof make clean surface contact with the upper and lower portions 21, 22 of the windshield 20.

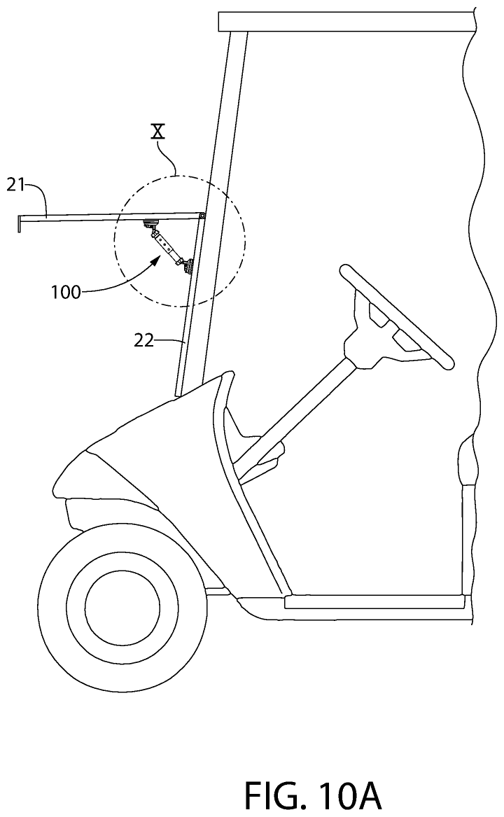

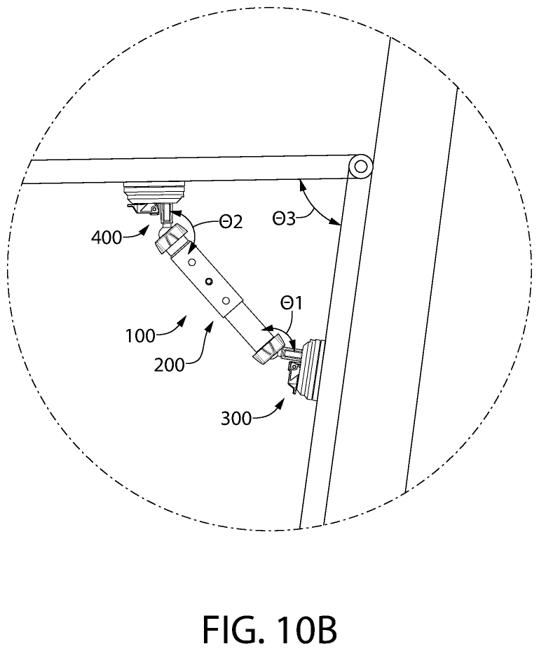

For example, in FIGS. 9A and 9B the third angle Θ3 is an obtuse angle. Referring to FIGS. 10A and 10B, the third angle Θ3 is approximately between 80° and 90°. The support apparatus 100 is adjusted (relative to how it appears in FIGS. 9A and 9B) to allow it to support the upper portion 21 of the windshield 20 at the angle shown in FIGS. 10A and 10B. In particular, in FIGS. 10A and 10B, relative to FIGS. 9A and 9B, the first suction cup assembly 300 is positioned lower along the lower portion 22 of the windshield, the length L1 of the arm assembly 200 has been increased in the manner discussed previously, and the first and second angles Θ1, Θ2 between the first and second suction cup assemblies 300, 400 and the arm assembly 200, respectively, have been adjusted.

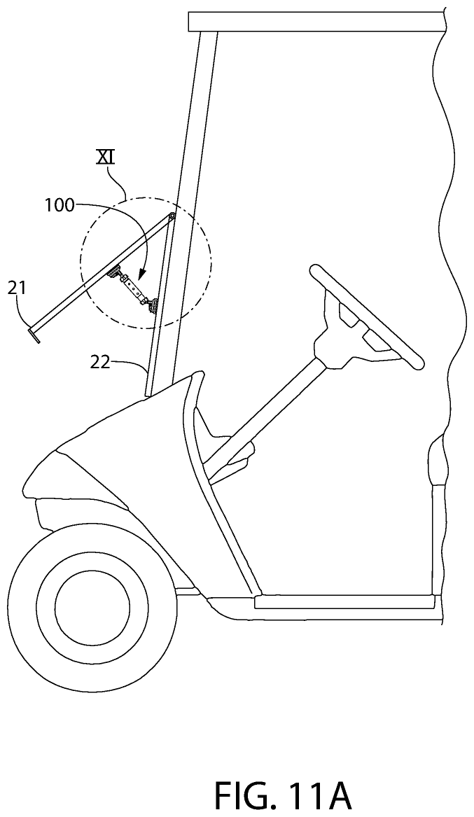

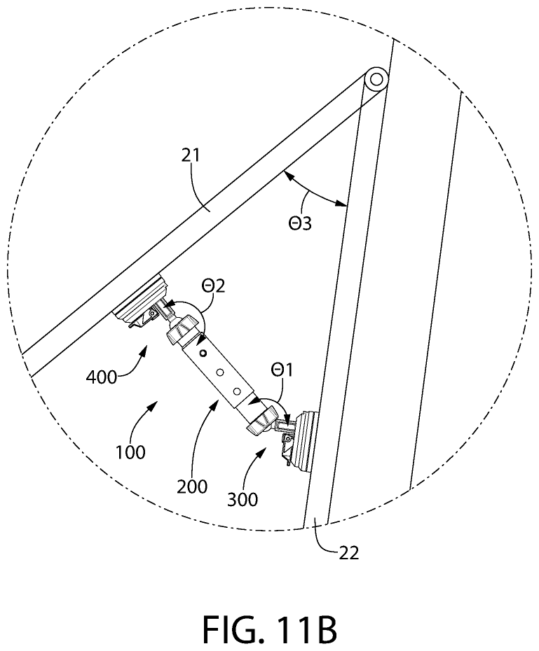

In FIGS. 11A and 11B, the upper portion 21 of the windshield 20 is supported and/or maintained at an even smaller angle relative to the lower portion 22 of the windshield 20. In FIGS. 11A and 11B, the third angle Θ3 may be between 20° and 40°, for example. Once again, the support apparatus 100 is adjusted as described herein to enable it to support the upper portion 21 of the windshield 20 at this position. In particular, the length L1 of the arm assembly 200 is once again reduced using the function described above. Furthermore, the first suction cup assembly 300 is positioned lower along the lower portion 22 of the windshield 20, and the first and second angles Θ1, Θ2 between the first and second suction cup assemblies 300, 400 and the arm assembly 200, respectively, have been adjusted.

Many other adjustments are possible. For example, the third angle Θ3 may be modified by positioning the support apparatus 100 lower down along the lower portion 22 of the windshield 20 without adjusting the length L1 of the arm assembly 100. One of the first and second angles Θ1, Θ2 may require adjustment to facilitate proper adhesion of the first and second suction cup assemblies 300, 400 to the upper and lower portions 21, 22 of the windshield 20, but this is achieved very simply due to the ball and socket attachment between each of the first and second suction cup assemblies 300, 400 and the arm assembly 200. Alternatively, the length L1 of the support apparatus 100 may be adjusted without changing the location of the support apparatus 100, which would result in the third angle Θ3 changing. Again, in this scenario the second angle Θ2 would also likely change to accommodate the orientation of the upper portion 21 of the windshield 20.

As used throughout, ranges are used as shorthand for describing each and every value that is within the range. Any value within the range can be selected as the terminus of the range. In addition, all references cited herein are hereby incorporated by referenced in their entireties. In the event of a conflict in a definition in the present disclosure and that of a cited reference, the present disclosure controls.

While the invention has been described with respect to specific examples including presently preferred modes of carrying out the invention, those skilled in the art will appreciate that there are numerous variations and permutations of the above described systems and techniques. It is to be understood that other embodiments may be utilized and structural and functional modifications may be made without departing from the scope of the present invention. Thus, the spirit and scope of the invention should be construed broadly as set forth in the appended claims.

1. A support apparatus for maintaining a golf cart windshield having an upper portion and a lower portion that are hingedly coupled together in a partially open state, the support apparatus comprising:
an arm assembly comprising a first end, a second end, and a length measured between the first and second ends, wherein the length of the arm assembly is adjustable;
a first suction cup assembly pivotably coupled to the first end of the arm assembly, the first suction cup assembly extending from the first end of the arm assembly at a first angle that is adjustable by pivoting the first suction cup assembly relative to the arm assembly;
a second suction cup assembly pivotably coupled to the second end of the arm assembly, the second suction cup assembly extending from the second end of the arm assembly at a second angle that is adjustable by pivoting the second suction cup assembly relative to the arm assembly; and
wherein the first suction cup assembly is configured for attachment to the lower portion of the golf cart windshield and the second suction cup assembly is configured for attachment to the upper portion of the golf cart windshield to support the upper portion of the golf cart windshield at a third angle relative to the lower portion of the golf cart windshield, wherein the third angle is adjustable by altering one or more of: (1) the length of the arm assembly; (2) the first angle; (3) the second angle; and (4) a position of the first suction cup assembly along the lower portion of the golf cart windshield.

2. The support apparatus according to claim 1 wherein the arm assembly comprises a locking feature that locks the arm assembly in a plurality of different lengths.

3. The support apparatus according to claim 2 wherein the arm assembly further comprises:
a longitudinal axis;
a first arm component comprising the first end, an outer surface, an inner surface that defines a hollow interior, and a plurality of locking apertures that extend from the outer surface to the inner surface in an axially spaced apart manner;
a second arm component comprising the second end, an outer surface, and a locking protuberance extending from the outer surface; and
wherein a portion of the second arm component nests within the hollow interior of the first arm component, the first and second arm components being slidable relative to one another to adjust the length of the arm assembly, and wherein the locking protuberance of the second arm component is configured to extend into one of the plurality of locking apertures of the first arm component to lock the arm assembly in one of the plurality of different lengths.

4. The support apparatus according to claim 1 further comprising:
the first suction cup assembly comprising:
a first rigid shell comprising a first body portion comprising a bottom end and a top end, and a first connection element, the first connection element comprising a first post portion extending from the top end of the first body portion of the first rigid shell and a first ball portion attached to a distal end of the first post portion; and
a first flexible sealing member located at the bottom end of the first body portion of the first rigid shell; and
the second suction cup assembly comprising:
a second rigid shell comprising a second body portion comprising a bottom end and a top end, and a second connection element, the second connection element comprising a second post portion extending from the top end of the second body portion of the second rigid shell and a second ball portion attached to a distal end of the second post portion; and
a second flexible sealing member located at the bottom end of the first body portion of the second rigid shell.

5. The support apparatus according to claim 4 wherein the first ball portion is at least partially disposed within an interior of the arm assembly at the first end of the arm assembly to pivotably couple the first suction cup to the arm assembly and wherein the second ball portion is at least partially disposed within the interior of the arm assembly at the second end of the arm assembly to pivotably couple the second suction cup assembly to the arm assembly.

6. The support apparatus according to claim 5 further comprising a first collar threadedly coupled to the first end of the arm assembly to secure the first suction cup assembly to the arm assembly and a second collar threadedly coupled to the second end of the arm assembly to secure the second suction cup assembly to the arm assembly.

7. The support apparatus according to claim 4 wherein the first post portion of the first connection element is offset from a centerpoint of the top end of the first body portion of the first rigid shell and wherein the second post portion of the second connection element is offset from a centerpoint of the top end of the second body portion of the second rigid shell.

8. The support apparatus according to claim 4 further comprising:
the first suction cup assembly comprising a first actuation assembly operably coupled to the first flexible sealing member and alterable between a non-actuated state and an actuated state, wherein altering the first actuation assembly from the non-actuated state to the actuated state while the first flexible sealing member is in contact with the lower portion of the golf cart windshield causes the first suction cup assembly to become adhered to the lower portion of the golf cart windshield; and
the second suction cup assembly comprising a second actuation assembly operably coupled to the second flexible sealing member and alterable between a non-actuated state and an actuated state, wherein altering the second actuation assembly from the non-actuated state to the actuated state while the second flexible sealing member is in contact with the upper portion of the golf cart windshield causes the second suction cup assembly to become adhered to the upper portion of the golf cart windshield.

9. (canceled)

10. The support apparatus according to claim 1 wherein the arm assembly comprises a longitudinal axis, and wherein each of the first and second suction cup assemblies is configured to rotate 360° relative to the arm assembly about the longitudinal axis and to pivot relative to the arm assembly at all rotational positions relative to the arm assembly.

11. The support apparatus according to claim 1 wherein the arm assembly comprises a longitudinal axis, and wherein a centerpoint of each of the first and second suction cup assemblies is offset from the longitudinal axis.

12. (canceled)

13. The support apparatus according to claim 1 further comprising:
the arm assembly comprising:
a first end portion comprising external threads and a plurality of circumferentially spaced apart slits extending from the first end of the arm assembly towards the second end of the arm assembly to define a plurality of first tabs; and
a second end portion comprising external threads and a plurality of circumferentially spaced apart slits extending from the second end of the arm assembly towards the first end of the arm assembly to define a plurality of second tabs;
the first suction cup assembly comprising a first ball portion that nests within an interior of the first end portion of the arm assembly;
the second suction cup assembly comprising a second ball portion that nests within an interior of the second end portion of the arm assembly;
a first collar having internal threads that engage the external threads of the first end portion of the arm assembly to couple the first collar to the arm assembly, the first collar forcing the plurality of first tabs to flex inwardly into engagement with the first ball portion of the first suction cup assembly to lock the first ball portion of the first suction cup assembly within the interior of the second end portion of the arm assembly; and
a second collar having internal threads that engage the external threads of the second end portion of the arm assembly to couple the second collar to the arm assembly, the second collar forcing the plurality of second tabs to flex inwardly into engagement with the second ball portion of the second suction cup assembly to lock the second ball portion of the second suction cup assembly within the interior of the first end portion of the arm assembly.

14. The support apparatus according to claim 1 wherein the first and second suction cup assemblies are each coupled to the arm assembly via a ball and socket joint.

15. A golf cart comprising:
a windshield comprising a lower portion, an upper portion, and a hinge connecting the upper portion to the lower portion, wherein the upper portion is pivotable relative to the lower portion about the hinge to alter the windshield between a closed state and an open state;
a support apparatus comprising:
an arm assembly comprising a first end, a second end, and a length measured between the first and second ends, wherein the length of the arm assembly is adjustable;
a first suction cup assembly pivotably coupled to the first end of the arm assembly; and
a second suction cup assembly pivotably coupled to the second end of the arm assembly; and
wherein the first suction cup assembly is adhered to the lower portion of the windshield and the second suction cup assembly is adhered to the upper portion of the windshield to maintain the windshield in a partially open state.

16. The golf cart according to claim 15 wherein the first suction cup assembly extends from the first end of the arm assembly at a first angle that is adjustable by pivoting the first suction cup assembly relative to the arm assembly and wherein the second suction cup assembly extends from the second end of the arm assembly at a second angle that is adjustable by pivoting the second suction cup assembly relative to the arm assembly.

17. The golf cart according to claim 16 wherein the support apparatus is configured to maintain the upper portion of the golf card windshield at a third angle relative to the lower portion of the golf cart windshield, the third angle being adjustable by altering one or more of:
(1) the length of the arm assembly; (2) the first angle; (3) the second angle; and (4) a position of the first suction cup assembly along the lower portion of the golf cart windshield.

18. The golf cart according to claim 15 wherein when the windshield is in the closed state the upper and lower portions of the windshield lie on a common plane, when the windshield is in the open state the upper portion of the windshield overlies the lower portion of the windshield, and when the windshield is in the partially open state the upper and lower portions of the windshield form an angle between 10° and 150°.

19. The golf cart according to claim 15 further comprising:
the first suction cup assembly comprising:
a first rigid shell comprising a first body portion comprising a bottom end and a top end having a centerpoint, and a first connection element, the first connection element comprising a first post portion extending from the top end of the first body portion of the first rigid shell at a position that is offset from the centerpoint and a first ball portion attached to a distal end of the first post portion; and
a first flexible sealing member located at the bottom end of the first body portion of the first rigid shell; and
the second suction cup assembly comprising:
a second rigid shell comprising a second body portion comprising a bottom end and a top end having a centerpoint, and a second connection element, the second connection element comprising a second post portion extending from the top end of the second body portion of the second rigid shell at a position that is offset from the centerpoint and a second ball portion attached to a distal end of the second post portion; and
a second flexible sealing member located at the bottom end of the second body portion of the second rigid shell.

20. The golf cart according to claim 15 wherein the first ball portion is at least partially disposed within an interior of the arm assembly at the first end of the arm assembly to pivotably couple the first suction cup to the arm assembly and wherein the second ball portion is at least partially disposed within the interior of the arm assembly at the second end of the arm assembly to pivotably couple the second suction cup assembly to the arm assembly.

21. The golf cart according to claim 15 wherein the arm assembly comprises a locking feature that locks the arm assembly in one of a plurality of different lengths.

22. A method of controlling air flow through a windshield of a golf cart, the method comprising:
attaching a first suction cup assembly that is pivotably coupled to a first end of an arm assembly of a support apparatus to a lower portion of the windshield of the golf cart;
adjusting a length of the arm assembly;
pivoting an upper portion of the windshield of the golf cart towards the lower portion of the windshield of the golf cart until the upper portion of the windshield of the golf cart is at a desired angle relative to the lower portion of the windshield of the golf cart; and
attaching a second suction cup assembly that is pivotably coupled to a second end of the arm assembly of the support apparatus to the upper portion of the windshield of the golf cart to maintain the upper portion of the windshield of the golf cart at the desired angle.

23-26. (canceled)
